(19) United States
(12) Patent Application Publication
(10) Pub. No.: US 2016/0300562 A1
(43) Pub. Date: Oct. 13, 2016

(54) ADAPTIVE FEEDBACK CONTROL FOR EARBUDS, HEADPHONES, AND HANDSETS

(71) Applicant: Apple Inc., Cupertino, CA (US)

(72) Inventor: Andre L. Goldstein, San Jose, CA (US)

(21) Appl. No.: 14/682,013

(22) Filed: Apr. 8, 2015

(51) Int. Cl. G10K 11/175

(52) U.S. Cl. CPC G10K 11/175; G10K 2210/1081

(57) ABSTRACT

A system and method are described in which additional signal processing is performed during in-the-field use of a personal listening device so that a control filter of a running acoustic noise cancellation process is selected based on the delta/difference between reference and residual error microphone signals of the device. This delta value represents the passive sound attenuation provided by the personal listening device. In other words, the control filter, which may be a programmable digital filter, is selected directly based on the delta between the level of external and error microphones. This delta value serves as an estimate of the current fit/leakage scenario, which enables the resulting anti-noise signal to better match a wide range of acoustic leaks (that may be caused by different earphone fits within the user's ear, or different ways a phone handset is held against the ear).

An embodiment of the invention relates to personal listening audio devices such as earphones, headphones and telephone handsets, and in particular the use of acoustic noise cancellation or active noise control (ANC) to improve the user's listening experience by attenuating external or ambient background noise. Other embodiments are also described.

### BACKGROUND

It is often desirable to use personal listening devices when listening to music and other audio material, or when participating in a telephone call, in order to not disturb others that are nearby. When a compact profile is desired, users often elect to use in-ear earphones or headphones, sometimes referred to as earbuds. To provide a form of passive barrier against ambient noise, earphones are often designed to form some level of acoustic seal with the ear of the wearer. In the case of earbuds, silicone or foam tips of different sizes can be used to improve the fit within the ear and also improve passive noise isolation.

With certain types of earphones, such as loose fitting earbuds, there is significant acoustic leakage between the atmosphere or ambient environment and the user's ear canal, past the external surfaces of the earphone housing and into the ear. This acoustic leakage could be due to the loose fitting nature of the earbud housing, which promotes comfort for the user. However, the additional acoustic leakage does not allow for enough passive attenuation of the ambient noise at the user's eardrum. The resulting poor passive acoustic attenuation can lead to lower quality user experience of the desired user audio content, either due to low signal-to-noise ratio or speech intelligibility especially in environments with high ambient or background noise levels. In such a case, an acoustic noise cancellation or active noise control (ANC) mechanism may be effective to reduce the background noise and thereby improve the user's experience.

ANC is a technique that aims to “cancel” unwanted noise, by introducing an additional, electronically controlled sound field referred to as anti-noise. The anti-noise is electronically designed so as to have the proper pressure amplitude and phase that destructively interferes with the unwanted noise or disturbance. An error sensor (typically an acoustic error microphone) is provided in the earphone housing to detect the so-called residual or error noise. The output of the error microphone is used by a control system to adjust how the anti-noise is produced, so as to reduce the ambient noise that is being heard by the wearer of the earphone.

The amplitude and phase characteristics of the anti-noise needed for achieving effective noise control are a result of processing the noise, as captured by one or more sensors, through a control filter. An ANC system in general can be implemented in a feedback or a feed forward topology, or a hybrid topology. Generally, the control filter processes ambient noise content that has been measured or is contained in the output of a sensing microphone (for example, the error microphone and in some cases also a reference microphone). The control filter does so based on an assumption that a certain electroacoustic response exists between the earphone (or headphone) speaker driver and the error microphone, when the earphone has been placed in or against the ear. This electroacoustic response is often referred to as the plant S, or the secondary acoustic path transfer function S(z), where this reference is in view of a primary acoustic path P(z) that is taken by the disturbance in arriving at the error microphone. In a feedback type of ANC system, a signal representing the residual error (reflecting the disturbance) as picked up by the error microphone is fed to the control filter, which in turn produces the anti-noise.

The control filter is intended to create an anti-noise that destructively interferes with the disturbance that has arrived at the error microphone through the primary acoustic path. In a feed forward system, the input signal to the control filter is derived from the output of a reference microphone which is located so as to pickup the disturbance before the disturbance has passed through the primary acoustic path. In a hybrid approach, elements of the feed forward and feedback topologies are combined to produce an anti-noise based on both an output of the reference microphone and an output of the error microphone.

### SUMMARY

The size of the acoustic leakage (or sound transmission) between the earpiece speaker and the user's ear can vary between different users of a personal listening audio device (e.g., an earbud, an over the ear headphone, a mobile phone handset), and also for different instances of normal use of the audio device by the same user. This may be due to different fits inside the ear, or different holding positions of the earpiece speaker housing against the outside of the ear during in-the-field use (“online” use). This variation in acoustic leakage (or sound transmission) impacts the delta/difference between a reference microphone signal and a residual error signal of the device. This “delta” represents the passive attenuation, which is the difference between the sound measured at the ear with the device on and off the ear

In accordance with an embodiment of the invention, additional signal processing is performed during in-the-field use of a personal listening device so that a control filter of a running ANC process is selected based on the delta/difference between an external reference microphone signal and a residual error signal of the device. This delta value may represent the passive sound attenuation provided by the personal listening device. In other words, the control filter, which may be a programmable digital filter, is selected directly based on the delta between the sound pressure level (SPL) of an external microphone and an error microphone. This delta value serves as an estimate of the current fit/leakage scenario, which enables the resulting anti-noise signal to better match a wide range of acoustic leaks (that may be caused by different earphone fits within the user's ear, or different ways in which a phone handset is held against the ear). Several techniques for doing so are described.

The above summary does not include an exhaustive list of all aspects of the present invention. It is contemplated that the invention includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one.

FIG. 1 is a block diagram of part of a consumer electronics personal listening system or device in which an embodiment of the invention can be implemented.

FIG. 2 shows a detailed block diagram of the personal listening audio device in which acoustic leak estimation and control filter adaptation processing is performed to enhance the effectiveness of active noise control (ANC) according to one embodiment of the invention.

FIG. 3A shows an example of a target ANC curve used by a control logic block of the personal listening audio device to perform ANC according to one embodiment of the invention.

FIG. 3B shows an example of a target ANC curve in relation to an actual recorded ANC curve according to one embodiment of the invention.

FIG. 3C shows an example of a target ANC curve in relation to an actual recorded ANC curve according to another embodiment of the invention.

FIG. 4 shows a set of threshold comparisons that may be used for determining whether an attack (gain increase) or release (gain decrease) should be performed such that the target curve is achieved/met according to one embodiment of the invention.

FIG. 5 shows a look-up table of gain ranges and associated control filter G_{adapt}(Z) identifiers according to one embodiment of the invention.

FIG. 6 is a Bode plot of several example control filters G_{adapt} (z) according to one embodiment of the invention.

### DETAILED DESCRIPTION

Several embodiments of the invention with reference to the appended drawings are now explained. Whenever the shapes, relative positions and other aspects of the parts described in the embodiments are not clearly defined, the scope of the invention is not limited only to the parts shown, which are meant merely for the purpose of illustration. Also, while numerous details are set forth, it is understood that some embodiments of the invention may be practiced without these details. In other instances, well-known circuits, structures, and techniques have not been shown in detail so as not to obscure the understanding of this description.

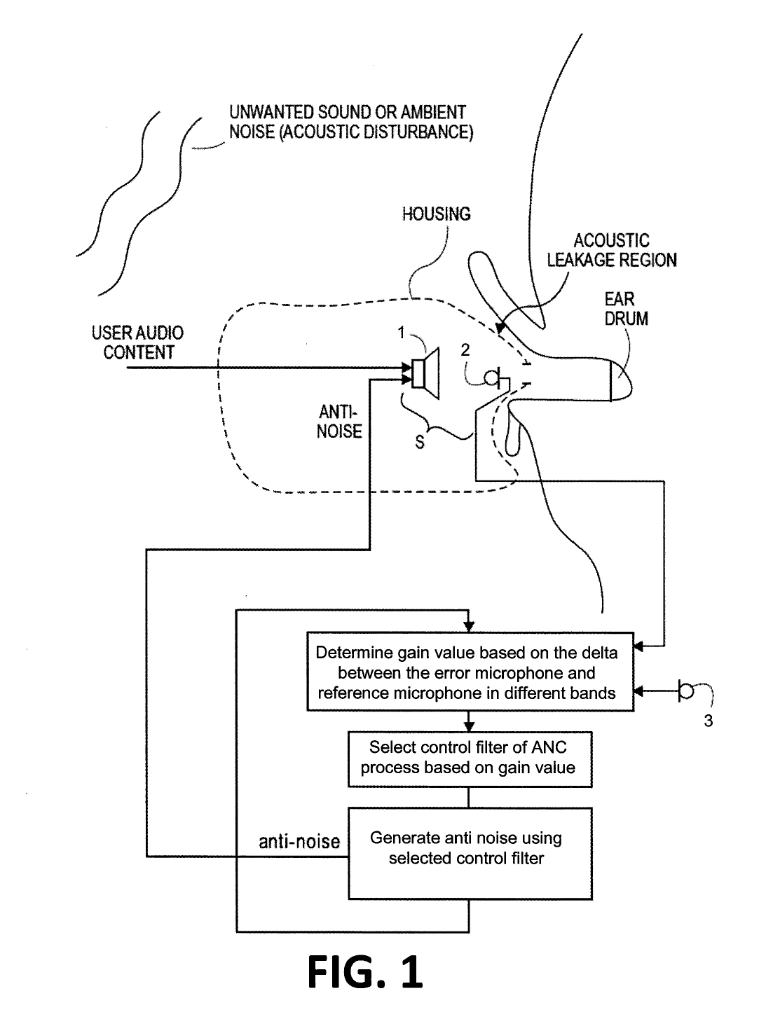

FIG. 1 is a block diagram of part of a consumer electronics personal listening system or device in which an embodiment of the invention can be implemented. The diagram is also used here to describe operations that are part of a method for in-the-field use of the personal listening device or system, in which an active noise control (ANC) process is performed. The personal listening system or ANC audio device depicted here has a housing in which a speaker driver system 1 is located in addition to an error microphone 2. The housing, also referred to as a speaker housing, is to be held against or inside a user's ear as shown, with the error microphone 2 and speaker driver system 1 integrated therein.

The speaker driver system 1 is to convert an audio signal, which may include user audio content or an ANC training audio sweep signal, into sound. This sound will be heard by the user/listener of the personal listening system or device in addition to unwanted sound or ambient noise (also referred to as acoustic disturbance) that manages to leak past the speaker housing and into the user's ear canal. The housing may be, for example, that of a wired or wireless headset, a loose-fitting earbud, a supra-aural headphone, or an earpiece speaker portion of a mobile phone handset. In the case of an earphone (headphone), the user audio content may be delivered through a wired or wireless connection (not shown) from an audio source device such as a smartphone, a tablet computer, or a laptop computer (e.g., via a wireless Bluetooth link). In all of these instances, there is a variable acoustic leakage region (or transmission path that could include sound transmission through mechanical vibrations) where the disturbance can leak past the housing and into the ear canal. The anti-noise produced by the speaker driver system 1 based on an output of a control filter should attenuate at least some of this disturbance as heard by the user.

Although shown in FIG. 1 as being separate from the housing, in some instances the housing may also include a reference microphone 3, which would be positioned typically at an opposite end (that is external or measures ambient noise) or side of the housing as the error microphone 2 and the speaker driver system 1, in order to better pick-up the unwanted acoustic disturbances prior to these acoustic disturbances passing into the ear canal of the user. A signal derived from the reference microphone 3 output can be used by an ANC system, and in particular may be (1) used as input to an adaptive algorithm to select a control filter for generating an anti-noise signal and/or (2) fed to an input of the control filter in a feed forward ANC system.

Although not shown in FIG. 1, signals from the error microphone 2 and the reference microphone 3 are produced or converted into digital form for use by an ANC controller/process, which implements digital signal processing operations upon signals derived from the microphone signals to produce the anti-noise signal. The anti-noise signal may thereafter be converted into sound by the speaker driver system 1. It should be noted that in some cases, the speaker driver system 1 may have a single driver that receives both the user audio content and the anti-noise signal (which have been combined (summed) into a single audio signal being fed to a single driver). In other embodiments, dedicated drivers may be used for each signal. The ANC controller/process operates while the user is, for example, listening to a digital music file that is stored in the audio source device or while the user is conducting a conversation with a far-end user of a communications network in an audio or video phone call.

As shown generally in FIG. 1, the ANC controller, or the ANC process that is running in the personal listening device, may determine a gain value for attenuating ambient noise based on the deltas/differences between the error microphone and the reference microphone over several frequency bands. In some cases, an adaptive gain controller is initialized at a low control gain condition and then the gain is adjusted according to control logic such that the gain is increased until a target ANC gain curve is met, where the ANC gain curve represents the amount of attenuation provided by ANC (i.e., the sound pressure level (SPL) delta at the error microphone 2 with ANC on and off). Based on the generated (or resulting) gain value, a control filter may be selected for use during the generation of the anti-noise signal. In one embodiment, a set of control filters corresponding to separate fit conditions of the personal listening system to an ear of the user may be mapped to gain values during manufacture or design of the personal listening system. In this embodiment, a control filter is selected based on the generated gain value to meet the target ANC gain curve. The ANC gain curve represents the attenuation at the error microphone (typically at lower frequencies) and any overshoot/noise boosts (typically at higher frequencies). By selecting a control filter based on the characterization of the fit of the personal listening system (i.e., characterized by the gain value which is generated based on the delta between the error microphone and reference microphone), the ANC controller/process may adapt generated anti-noise to changing conditions. The ANC controller/process will be described in greater detail by way of example below.

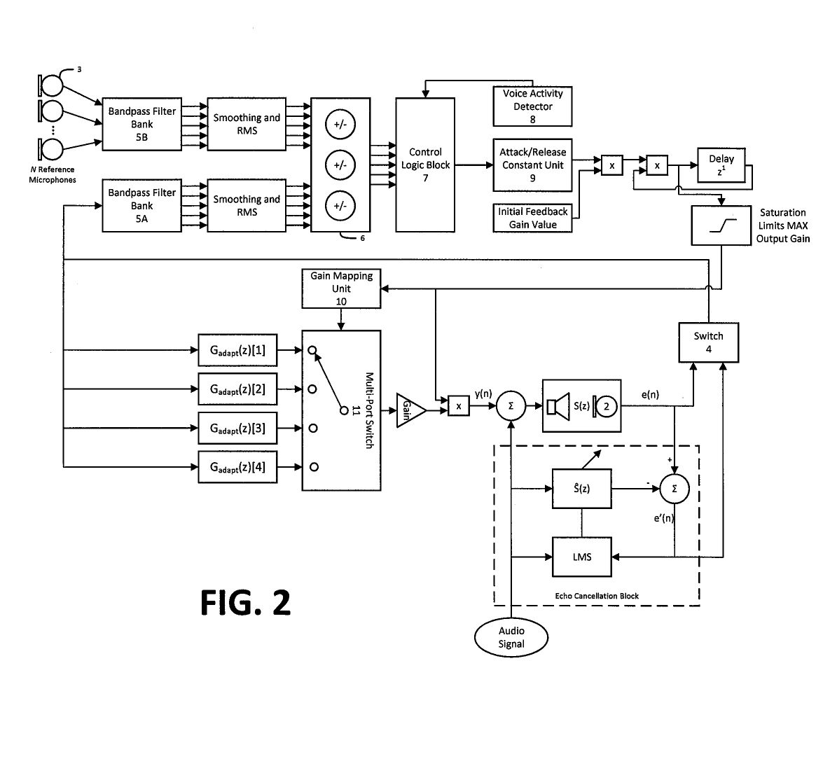

FIG. 2 is a detailed block diagram of a personal listening audio device in which acoustic leak estimation and control filter adaptation processing is performed to enhance the effectiveness of ANC. An audio signal may be received or generated by the personal listening audio device for playback to a user via the speaker driver system 1. The audio signal may be any audio signal, including a downlink signal from a remote device operating in a telecommunications network. The audio signal may be fed to an echo cancellation block along with a signal from the error microphone 2 as shown in FIG. 2. Although shown as including an audio signal, in some instances no audio signal is provided. Nevertheless, the ANC system/process may still adapt to remove effects of ambient noise despite the non-existence of an audio signal.

The echo cancellation block may be used to calculate a residual or playback corrected error signal e′(n) through computation of S_hat(z). In particular, the error microphone 2 may be situated to detect the audio signal played through the speaker driver system 1, ambient noise, and any anti-noise y(n) played through the speaker driver system 1. By computing S_hat(z), which represents an estimate of the transfer function between the speaker driver system 1 and the error microphone 2, the effects of the audio signal played through the speaker driver system 1 may be removed from the error microphone 2 signal using a summation device as shown in the echo cancellation block of FIG. 2. The resulting signal e′(n) is therefore composed of the sum of (1) ambient noise and (2) any anti-noise generated by the speaker driver system 1. In one embodiment, the computation of S_hat(z) may be an adaptive process. For example, a least mean square (LMS) adaptive ANC algorithm or other suitable adaptive algorithm) may be used to compute S_hat(z).

In one embodiment, the error microphone signal e(n) may be fed to a switch 4 along with the residual/corrected error signal e′(n) generated by the echo cancelation block. The switch 4 may determine whether an audio signal is present (i.e., currently being output by the speaker driver system 1 and currently being processed by the echo cancellation block). Upon determining that an audio signal is present, the switch 4 may select the corrected error estimate e′(n) for output. Conversely, upon determining that an audio signal is not present, the switch 4 may select the original error signal e(n) for output since removal of the audio signal using the summation device of the echo canceller is no longer needed. Hereinafter, the output of the switch 4 will be referred to as the error signal for simplicity; however, it is understood that this error signal may either be the original output of the error microphone 2 (i.e., the signal e(n)) or the output of the echo cancellation block (i.e., the residual/corrected error signal e′(n)).

The output of the switch 4 may be transmitted to both (1) a bandpass filter bank 5A and (2) a set of control filters G_{adapt}(Z). The signal flow for each of these paths will now be described. The bandpass filter bank 5A may be used to split the error signal from the switch 4 into a set of frequency bands that will be further analyzed to produce a corresponding set of gain values for achieving a target ANC curve. For example, the bandpass filter bank 5A may be used to split the error signal into ⅓rd octave bands components/bins. In other embodiments, different frequency divisions of uniform or non-uniform size may be used by the bandpass filter bank 5A.

As shown in FIG. 2, a set of signals from the reference microphones 3 may also be passed into a corresponding bandpass filter bank 5B. As shown, N reference microphones 3 may be used and corresponding signals processed by the bandpass filter bank 5B (where N is greater or equal to one). These reference microphones 3 may be situated together or in different areas of the consumer electronics personal listening system or device. Although multiple reference microphones 3 may be used, for simplicity, only one reference signal will be used herein. The bandpass filter bank 5B used for the reference microphone signal may be identical in design to the bandpass filter bank 5A used for the error signal. In particular, the bandpass filter bank 5B may split the reference microphone signal into identical frequency components as the bandpass filter bank 5A used for the error signal. This isolation of different frequency bands will allow for band comparison as will be described further below.

In some embodiments, smoothing may be applied to each individual frequency component/bin of both the error signal and the reference microphone signal over time. Smoothing may be performed using any known algorithm, and allows noise and other fine-scale structures/rapid phenomena to be removed from each of the signals. Following smoothing, the strength of each smoothed band signal may be computed. The strength may be an energy value, such as a root mean square (RMS) power value. Accordingly, separate energy levels are computed for each band of the reference signal and the error signal. In other embodiments, the above described processing may be performed in the frequency domain instead of the time domain. In these embodiments, instead of bandpass, smoothing, and RMS operations in the time domain, equivalent operations may be performed in the frequency domain. For example, in the frequency domain, a fast Fourier transform (FFT) may be used, the power spectral density (PSD) may be computed, and averaged in different frequency bands.

Using the difference unit 6, delta values between energy levels of corresponding bands of the reference signal and the error signal may be computed. In this embodiment, a delta value is generated for each pair of reference and error band signals. The delta values may be fed into a control logic block 7 and may be used to characterize the fit and corresponding leakage conditions for the consumer electronics personal listening system or device. When the headphone of the device is on the ear and ANC is turned OFF, the difference between the SPL at the reference microphone 3 and the SPL at the error microphone 2 gives the passive attenuation. When ANC is turned ON, the difference between the SPL at the reference microphone 3 and the SPL at the error microphone 2 gives the device total attenuation. The active attenuation is derived from the difference between the total and the passive attenuation. These deltas could also be used to determine if the device is on ear or off ear. That is, if passive attenuation does no match the factory preset, this could mean the device is not on the ear. In this case the ANC adaptation is frozen until the device is back on ear.

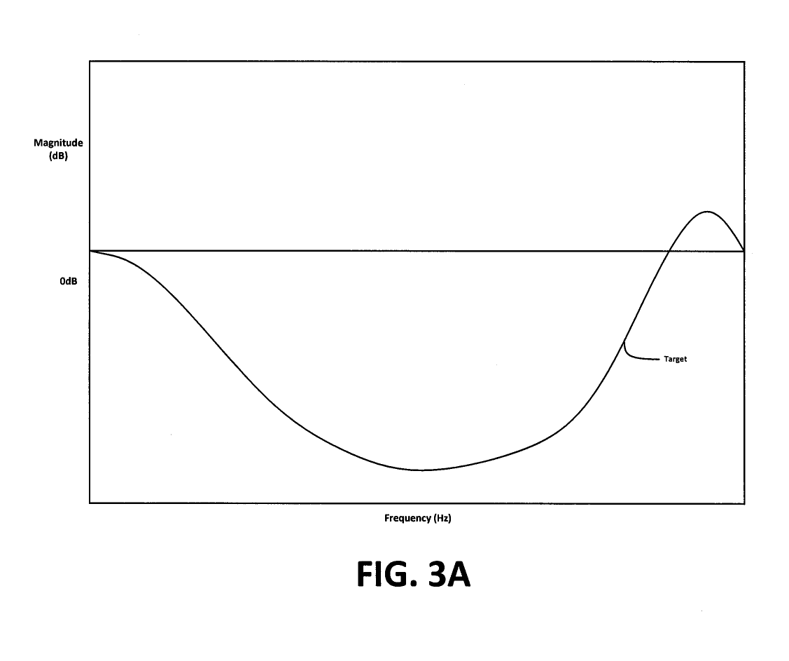

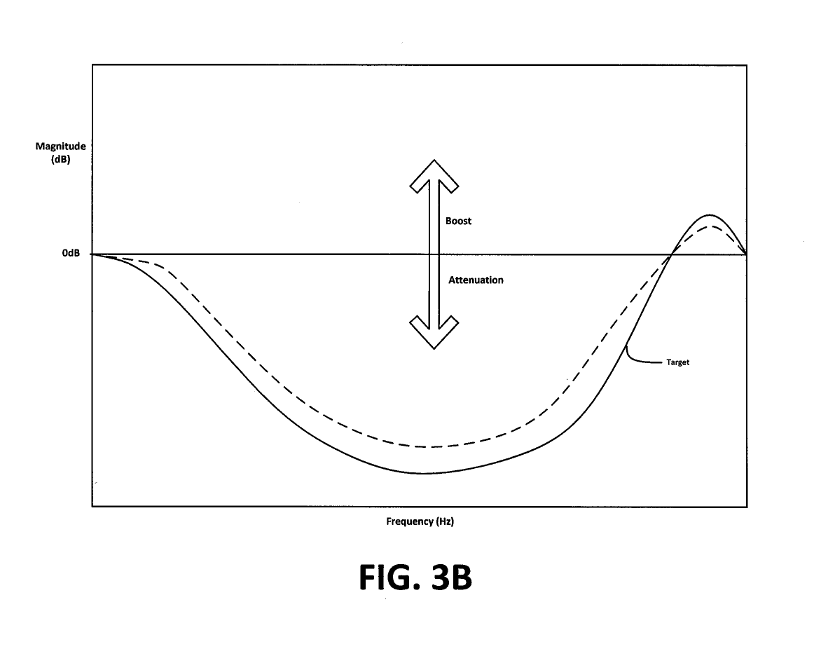

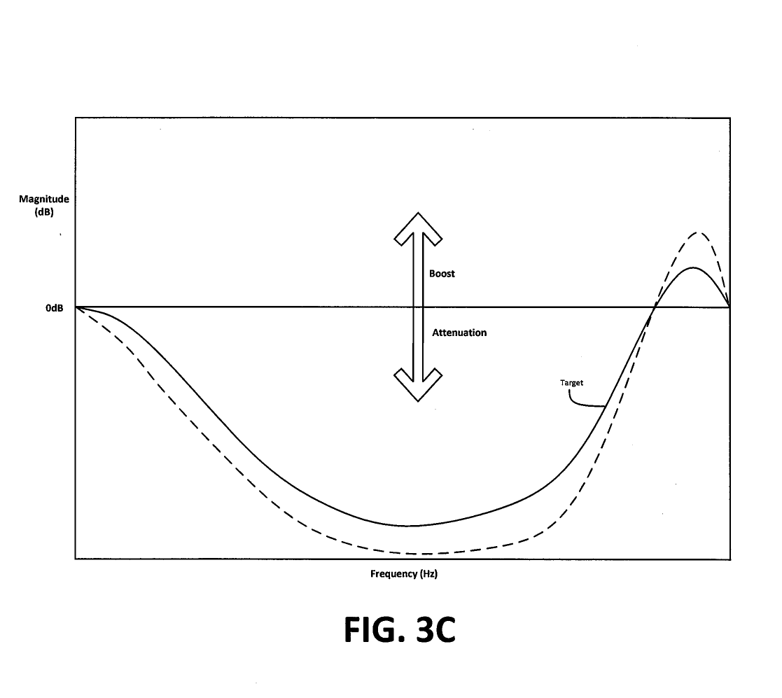

Using the delta values, the control logic block 7 may perform comparisons against a set of thresholds to determine whether a target is being met. For example, the target may represent an ideal curve of the difference between the reference microphone 3 and error microphone 2. FIG. 3A shows an example of a target ANC curve used by the control logic block 7. In one embodiment, the target curve shown in FIG. 3A may be computed/generated in a laboratory and preset during manufacture of the personal listening audio device. As noted above, the target curve represents the ideal difference between the reference microphone 3 and the error microphone 2 (e.g., the target curve reflects the difference between ANC being turned on and ANC being turned off).

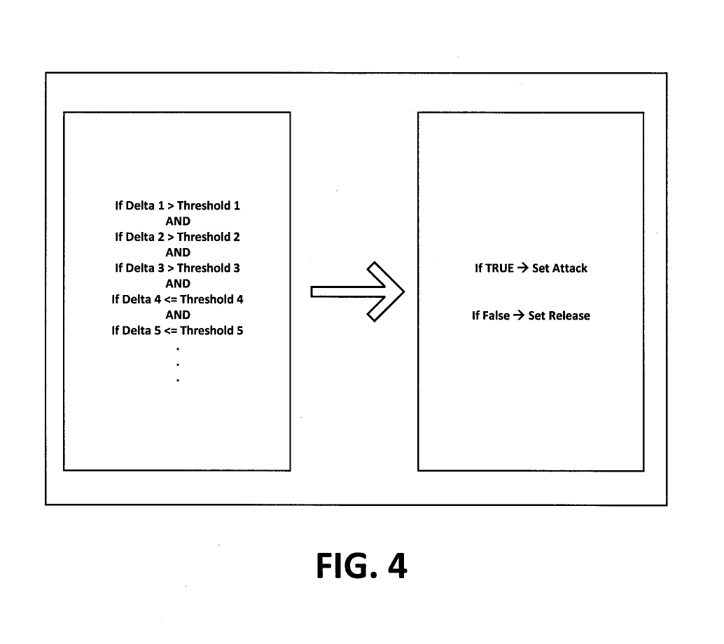

FIG. 4 shows a set of threshold comparisons that may be used for determining whether an attack or release should be performed such that the target curve is achieved/met. In FIG. 4, each delta corresponds to a separate frequency band and the thresholds correspond to the target curve. In general, when the difference between the reference microphone 3 and the error microphone 2 (represented by the dashed line) is above the target curve as shown in FIG. 3B, the control logic block 7 determines that an attack should be performed (i.e., gain is increased to meet the target curve). Conversely, when the difference between the reference microphone 3 and the error microphone 2 is below the target curve as shown in FIG. 3C, the control logic block 7 determines that a release should be performed (i.e., gain is decreased to meet the target curve).

In some embodiments, a voice activity detector 8 may analyze a microphone utilized by the user for uplink communications (i.e., a microphone separate from the reference microphone(s) and the error microphone). Upon detecting voice in uplink communications (i.e., voice from the user), the voice activity detector 8 may trigger the control logic block 7 to pause/stop adapting to meet the target curve. Otherwise, the control logic block 7 may proceed as normal when voice activity is not detected.

After the control logic block 7 determines whether a release or attack should be performed, the attack/release constant unit 9 may compute a constant, which reflects the degree/amount of attack or release to apply to the current gain to achieve the target curve. This constant may be multiplied by an initial feedback gain value (i.e., unity value) to produce a weighted gain value. In some embodiments, a new gain value is obtained by multiplying the previously computed gain by the attack or release constant as shown in FIG. 2. As shown, the delay block may generate a new gain value that is based on the old/input gain value with the attack/release applied. In general the attack constant may be slightly greater than 1.0 and the release constant may be less than 1.0) according to the required time constants (or desired reaction time) of the system. Further, in some embodiments a limit may be applied to the weighted gain value as also shown in FIG. 2 to limit the maximum output gain.

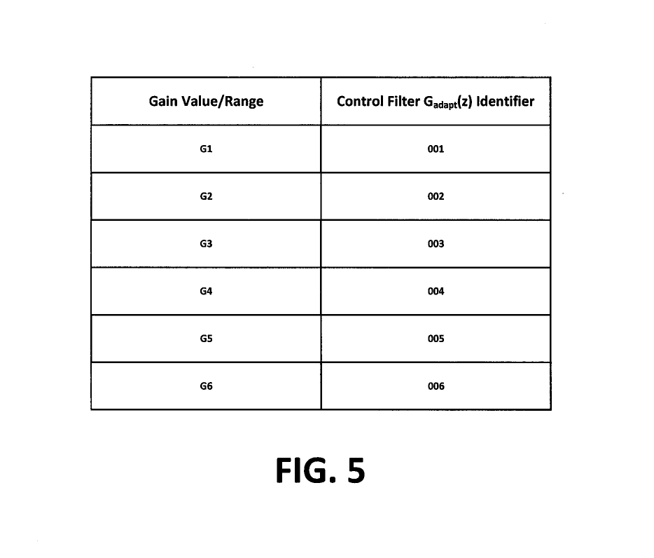

Following the generation of a gain value based on (1) the difference between the error microphone signal and the reference microphone signal and (2) the target curve, the generated weighted gain value may be fed into a gain mapping unit 10. The gain mapping unit 10 may include a set of gain values (or gain ranges) and associated control filter G_{adapt}(z) identifiers. FIG. 5 shows one example of a look-up table of gain ranges and associated control filter G_{adapt}(Z) identifiers. Upon receiving the weighted gain value, the gain mapping unit 10 may compare the received value with values (or ranges) in the table to retrieve a corresponding control filter G_{adapt}(Z) identifier.

In general, the range of plant variations may be characterized (measured) during a design stage of the device. Accordingly, all possible plants may be measured for all users and for all fits during this design stage. Usually this results in a collection of plants with a continuum of different gains. Thereafter, stable feedback controllers (with different gains) (the G_{adapt}(z) control filters) are designed to match the gain in the plant response so as to achieve the same active attenuation, or the target ANC gain curve. Thus, there is a pairing between plant response and feedback control filter. In general, the more gain there is in the plant (response from speaker to error microphone), the less gain is needed in the controller. For example in an over-the-ear headphone, where there is a sealed front volume (between the speaker and the ear), for a given speaker/microphone, the gain will be higher for smaller volumes and lower for bigger volumes.

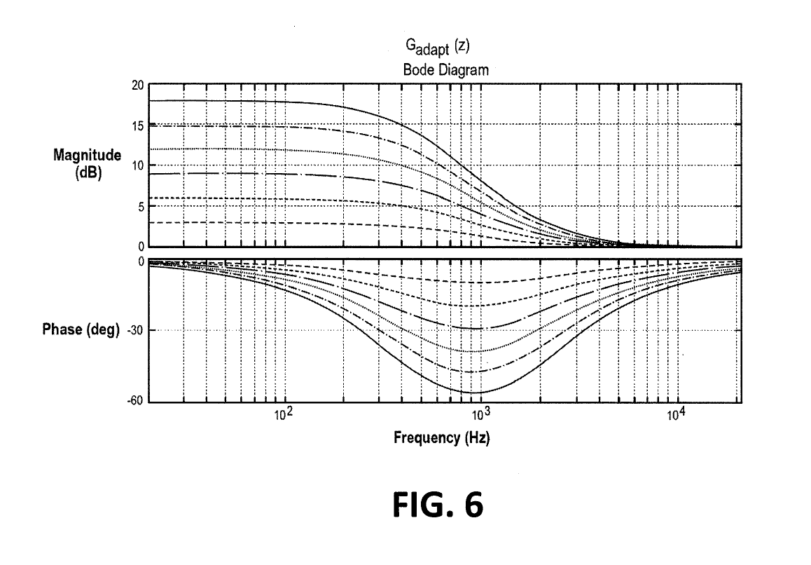

The control filters G_{adapt}(z) are digital control filters that are used in an ANC process to produce the anti-noise signal y(n). In one embodiment, each of these digital filters G_{adapt}(z) can be specified by its coefficients, which may be stored with the associated gain value/range as part of the look-up table in each production specimen of the audio device. Alternatively, the filter G_{adapt}(z) specification may be given as a number of characteristic filter parameters, such as a filter order, a cut-off frequency, a quality factor (Q), and others, which may be stored in association with each gain range in the look-up table. In one embodiment, each specification for the control filters G_{adapt}(z) refers to a respective low frequency shelf filter, e.g., having a knee between 200 Hz and 600 Hz with different low frequency gains but essentially zero high frequency gain, e.g., above 3 kHz. Examples of such shelf filters are depicted by the transfer functions shown in FIG. 6.

In response to determining a control filter G_{adapt}(Z) based on the received weighted gain value, the gain mapping unit 10 may trigger the multi-port switch 11 to select the chosen control filter G_{adapt}(z) for use in generating the anti-noise signal y(n). In another embodiment, instead of the multi-port switch 11, there could be a table look up that writes sets of coefficients to a programmable filter. As previously noted, the output of the switch 4 may be output to be processed by the selected control filter G_{adapt}(z). The selected G_{adapt}(Z) may use the output of the switch 4 (i.e., either the original error microphone signal e(n) or the corrected/residual error signal e′(n)) to generate the anti-noise signal y(n).

In some embodiments, an additional full band gain may be applied before the anti-noise signal y(n) is combined with the weighted gain value. As noted above, this full band gain is optional and in embodiments in which no additional gain is added, the output of the switch 11 may be multiplied by the gain from the saturation block. After output from the switch 11 and application of optional gain, the anti-noise signal y(n) may thereafter be output along with an audio signal (if present) through the speaker driver system 1 such that both the anti-noise signal y(n) and the audio signal may be heard by a user, as shown in FIG. 1 and FIG. 2. As described, the ANC process reduces the effects of ambient noise during different fit/leakage conditions (between the housing and the ear of a user) without the need for an intended audio signal to be present (e.g., a downlink signal, a music signal, etc.). In particular, a control filter G_{adapt}(Z), which may be a programmable digital filter, is selected directly based on the delta between the level of external and error microphones. This delta value serves as an estimate of the current fit/leakage scenario, which enables the resulting anti-noise signal to better match a wide range of acoustic leaks (that may be caused by different earphone fits within the user's ear, or different ways a phone handset is held against the ear). Since the delta/difference between the level of external and error microphones is not reliant on the presence of played back audio, the ANC process may be intelligently customized to the current fit/leakage condition without the need for an audio signal. Although often described herein in relation to leakage conditions, in the case of an over the ear headphone, a different fit could be a change in pressure against the ear that squishes the ear pads and causes a change in the front volume. In this case, acoustic leakage does is not present, but instead a different fit condition that needs to be accounted.

Although shown in a feedback design configuration (i.e., the anti-noise y(n) is generated based on an error signal (i.e., the error signal e(n) or the residual/corrected error signal e′(n)), in some embodiments, a feedforward or hybrid approach may be used in which a reference microphone signal may be used to generate the anti-noise signal y(n).

In a feedforward case, the control filters may be the combination of a low frequency component W_{LF}(z) and a series-connected high frequency component W_{HF}(z). The latter is being adapted by an LMS adaptive ANC algorithm (e.g., filtered-x LMS, or other suitable adaptive algorithm that uses the reference signal x), while the former is being adapted by an acoustic estimation process. In some embodiments, the feedback case the control filters may be the combination of a low frequency component G_{LF}(z) and a series-connected high frequency component G_{HF}(z) similar to the description above in relation to the feedforward case.

In a hybrid scenario, the anti-noise signal y(n) is produced by the following combination: the input of a selected control filter G_{adapt}(z) is coupled to a signal derived from an output of the error microphone (the feedback portion of the anti-noise), while the output of the control filter is combined with the output of a W-filter, the latter being adapted by, for example, an LMS adaptive ANC algorithm (the feed forward anti-noise producing portion).

As explained above, an embodiment of the invention may be a non-transitory machine-readable medium (such as microelectronic memory) having stored thereon instructions, which program one or more data processing components (generically referred to here as a “processor”) to perform the digital audio processing operations described above including signal strength measurement, filtering, addition, subtraction, inversion, comparisons, and decision making. In other embodiments, some of these operations might be performed by specific hardware components that contain hardwired logic (e.g., dedicated digital filter blocks). Those operations might alternatively be performed by any combination of programmed data processing components and fixed hardwired circuit components.

While certain embodiments have been described and shown in the accompanying drawings, it is to be understood that such embodiments are merely illustrative of and not restrictive on the broad invention, and that the invention is not limited to the specific constructions and arrangements shown and described, since various other modifications may occur to those of ordinary skill in the art. For example, instead of a simple low frequency shelf, higher order filters with more complex response could be used as part of G_{adapt}(Z). The description is thus to be regarded as illustrative instead of limiting.

What is claimed is:

1. A method for in-the-field use of a personal listening audio device, comprising:
computing a difference between a reference microphone signal from a reference microphone and an error microphone signal from an error microphone associated with the personal listening audio device;
generating a gain value for attenuating ambient noise based on the computed difference between the reference microphone signal and the error microphone signal;
selecting a control filter for use during performance of acoustic noise cancellation (ANC) based on the generated gain value; and
performing an ANC process during in-the-field use of the personal listening audio device using the selected control filter to produce an anti-noise signal by the device.

2. The method of claim 1, wherein the difference between the reference microphone signal and the error microphone signal is computed over multiple frequency bands such that multiple difference sound pressure level values are generated.

3. The method of claim 2, wherein generating the gain value comprises:
comparing the multiple generated difference sound pressure level values between the reference microphone signal and the error microphone signal with a target curve;
selecting an attack or release constant to meet the target curve based on the comparison between the multiple generated difference sound pressure level values and the target curve; and
applying the attack or release constant with an initial feedback gain value to produce the gain value.

4. The method of claim 1, wherein selecting the control filter comprises:
comparing the generated gain value with gain values associated with a plurality of control filters,
wherein each of the control filters is designed to achieve the target ANC gain for a different fit or leakage scenario between a housing of an earpiece of the personal listening audio device and an ear of a user and each control filter in the plurality of control filters is associated with a separate gain value,
wherein the selected control filter is associated with the generated gain value.

5. The method of claim 4, wherein the gain value associated with each control filter of the plurality of gain filters is a range of gain values.

6. The method of claim 1, further comprising:
generating an error corrected microphone signal based on the error microphone signal;
determining if an audio signal is present for playback by the personal listening audio device; and
upon determining that an audio signal is present, using the error corrected microphone signal to produce the anti-noise signal.

7. The method of claim 6, wherein the error corrected microphone signal is generated by:
computing an estimate of the plant response between the error microphone and a speaker driver system of the personal listening audio device; and
subtracting the audio signal that is modified by the estimated plant response from the error microphone signal to generate the error corrected microphone signal.

8. The method of claim 1, wherein the control filter is represented by a plurality of groups of digital filter coefficients, wherein each group of coefficients is associated with a respective one of a plurality of different acoustic leakage, sound transmission, or sound attenuation scenarios.

9. The method of claim 8, wherein the plurality of groups of digital filter coefficients define a plurality of low frequency shelf filters.

10. The method of claim 1, wherein the control filter has an input coupled to receive a signal derived from an output of the error microphone.

11. The method of claim 1, wherein the control filter has an input coupled to receive a signal derived from an output of the reference microphone.

12. The method of claim 1, further comprising:
comparing the difference between the reference microphone signal and the error microphone signal with a factory preset value; and
in response to the difference between the reference microphone signal and the error microphone signal failing to match with the factory preset value, determining that a housing of an earpiece of the personal listening audio device is off an ear of a user and halting adaptation of the ANC process.

13. An acoustic noise cancellation (ANC) audio device comprising:
a speaker housing to be held against or inside a user's ear, the housing having integrated therein an error microphone and a speaker driver system, wherein the speaker driver system is to convert an audio signal and an anti-noise signal into sound and wherein there is acoustic leakage past the speaker housing and into the user's ear canal;
a reference microphone located on an opposite end or side of the speaker housing as the error microphone;
a set of programmable digital filters to produce the anti-noise signal;
a set of logic circuits to compute a gain value based on the difference between an error microphone signal generated by the error microphone and a reference microphone signal generated by the reference microphone;
a gain mapping unit to select a digital filter from the set of programmable digital filters based on the gain value, wherein the selected digital filter generates the anti-noise signal.

14. The ANC audio device of claim 13, wherein the speaker housing is an earbud housing.

15. The ANC audio device of claim 13, wherein the speaker housing is an earpiece speaker housing portion of a mobile phone handset.

16. The ANC audio device of claim 13, wherein the difference between the reference microphone signal and the error microphone signal is computed over multiple frequency bands such that multiple difference values are generated.

17. The ANC audio device of claim 16, wherein the set of logic circuits compute the gain value by:
comparing the multiple generated difference values between the reference microphone signal and the error microphone signal with a target curve;
selecting an attack or release constant to meet the target curve; and
applying the attack or release constant with an initial feedback gain value to produce the gain value.

18. The ANC audio device of claim 13, wherein the gain mapping unit selects the digital filter by:
comparing the computed gain value with gain values associated with the set of programmable digital filters,
wherein each of the digital filters represents a different fit or leakage scenario between the speaker housing and an ear of a user and each digital filter in the set of programmable digital filters is associated with a separate gain value,
wherein the selected digital filter is associated with the computed gain value.

19. The ANC audio device of claim 18, wherein the gain value associated with each digital filter of the set of programmable digital filters is a range of gain values.

20. The ANC audio device of claim 13, further comprising:
an echo cancellation block to generate an error corrected microphone signal based on the error microphone signal; and
a switch to determine if an audio signal is present for playback by the speaker driver system and upon determining that an audio signal is present, the selected digital filter to use the error corrected microphone signal to produce the anti-noise signal.

21. A non-transitory machine-readable medium storing instructions that when executed by a processor of a personal listening audio device, cause the device to:
compute the difference between a reference microphone signal from a reference microphone and an error microphone signal from the an error microphone associated with the personal listening audio device;
generate a gain value for attenuating ambient noise based on the computed difference between the reference microphone signal and the error microphone signal;
select a control filter for use during performance of acoustic noise cancellation (ANC) based on the generated gain value; and
perform an ANC process during in-the-field use of the personal listening audio device using the selected control filter to produce an anti-noise signal by the device.
